(19) United States
(12) Patent Application Publication
(10) Pub. No.: US 2026/0162382 A1
(43) Pub. Date: Jun. 11, 2026

(54) METHOD PERFORMED BY MR HEADSET DEVICE AND MR HEADSET DEVICE

(71) Applicant: Samsung Electronics Co., Ltd., Suwon-si (KR)

(72) Inventors: Parameswaranath Vadackupurath MANI, Bangalore (IN); Anirudha Chandrashekhar HAJARE, Bangalore (IN); Mrinaal DOGRA, Bangalore (IN); Sonal SINGH, Bangalore (IN); Barath Raj Kandur RAJA, Bangalore (IN); Mansoor Variyathpara MOHAMMED, Bangalore (IN); Satish Madhukar PATIL, Bangalore (IN); Sreevatsa Dwaraka BHAMIDIPATI, Bangalore (IN)

(21) Appl. No.: 19/220,927

(22) Filed: May 28, 2025

Related U.S. Application Data
(63) Continuation of application No. PCT/KR2025/006420, filed on May 13, 2025.

(30) Foreign Application Priority Data
Dec. 10, 2024 (IN) 202411097389

(51) Int. Cl. G06T 19/00; G06F 3/01

(52) U.S. Cl. CPC G06T 19/006; G06F 3/013; G06F 3/017

(57) ABSTRACT

A method performed by a mixed reality (MR) headset device is provided. The method includes identifying, from an MR environment, at least one object of interest (OOI) and one or more physical surfaces surrounding the at least one OOI, determining user interface (UI) components associated with the at least one OOI based on the identification information of the at least one OOI, determining, based on defined parameters, an interact-ability score for each of a plurality of regions segmented from the one or more physical surfaces, determining a region for displaying the UI components associated with the at least one OOI among the plurality of regions segmented from the one or more physical surfaces based on the determined interact-ability score, and anchoring the UI components associated with the at least one OOI to the determined region for accessing the at least one OOI in the MR environment.

### CROSS-REFERENCE TO RELATED APPLICATION(S)

This application is a continuation application, claiming priority under 35 U.S.C. § 365(c), of an International application No. PCT/KR2025/006420, filed on May 13, 2025, which is based on and claims the benefit of an Indian Patent Application number 202411097389, filed on Dec. 10, 2024, in the Indian Intellectual Property Office, the disclosure of which is incorporated by reference herein in its entirety.

### TECHNICAL FIELD

The disclosure relates to a field of mixed reality (MR) systems. More particularly, the disclosure relates to a method and device for improving user interaction with objects in a Mixed Reality environment.

### BACKGROUND

Mixed reality (MR) systems bring together real world and digital elements. In the MR, a user can interact with and manipulate both physical and virtual items and environments, using next-generation sensing and imaging technologies. In particular, the MR operates by overlaying digitally generated content or entities (e.g., characters, text, hyperlinks, images, graphics, etc.) upon user's real-world and physical surroundings. A typical MR device includes a projection-based optical system that displays content on a translucent or transparent surface of a head mounted display (HMD), heads-up display (HUD), eyeglasses, or the like (collectively “HMDs”).

While the MR systems allow a user to interact with both real and virtual components, there are certain drawbacks to the state-of-the-art MR systems. These include the followings:
(a) Inadequate tactile and haptic feedback—current MR systems lack tactile feedback, which greatly affects user interaction accuracy. This leads to an unintuitive and frustrating experience when swiping, scrolling, dragging, and zooming, taking away from a potential immersion of these environments. Additionally, the insufficient haptic feedback makes it hard for users to feel the ‘click’ or confirmation of their interactions. This lack of tactile response causes uncertainty and requires visual confirmation, ultimately slowing down the interaction process.
(b) Depth perception challenges—in MR environments, users have difficulty judging a distance of user interface (UI) elements, leading to inaccurate selections and gestures, which slows down interactions and increase frustration. Directly overlaying UI components in MR systems blocks the user's view, causing distractions, reducing situational awareness, and diminishing the immersive experience, ultimately affecting usability and efficiency of systems.
(c) Fatigue from prolonged interaction—prolonged use of MR interfaces, especially those involving arm or hand gestures, can result in physical fatigue. This is particularly concerning in professional or training settings where users must engage with MR for mixed durations. Furthermore, continuously focusing on a fixed plane where traditional UIs are displayed can strain the eyes, exacerbating the fatigue experienced.
(d) Cross-device interaction in MR environment—the current method of interacting with multiple devices in MR environments is disjointed, imposing a heavy cognitive burden on users. Constant context-switching and inconsistent interaction schemes result in inefficiency and decreased productivity. Additionally, casting different UI schemes into the MR environment creates a fragmented experience when interacting with numerous connected devices. Currently, the user experience is limited to the UI support provided by each individual connected device.
(e) Inconsistent interaction models—MR systems often use varying interaction models (like gaze, gesture, or controller-based input) that can confuse users, especially when switching between different applications. This inconsistency hampers the user experience, leading to errors and a steep learning curve.

Therefore, there is a need for a MR system that overcomes the above-mentioned limitations.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for improving user interaction with objects in a Mixed Reality environment.

Additional aspects will be set forth in part in the description which follows and, in part, will be apparent from the description, or may be learned by practice of the presented embodiments.

In accordance with an aspect of the disclosure, a method performed by a mixed reality (MR) headset device is provided. The method includes identifying, from an MR environment, at least one object of interest and one or more physical surfaces surrounding the at least one object of interest. The method includes determining user interface (UI) components associated with the at least one object of interest based on the identification information of the at least one object of interest. The method includes determining, based on defined parameters, an interact-ability score for each of a plurality of regions segmented from the one or more physical surfaces, the interact-ability score indicates a degree to which the each of the plurality of regions is suitable for user interaction. The method includes determining a region for displaying the UI components associated with the at least one object of interest among the plurality of regions segmented from the one or more physical surfaces based on the determined interact-ability score, and the method includes anchoring the UI components associated with the at least one object of interest to the determined region for accessing the at least one object of interest in the MR environment.

In accordance with an aspect of the disclosure, a mixed reality (MR) headset device is provided. The MR headset device includes memory, comprising one or more storage media, storing instructions. The MR headset device includes at least one processor comprising processing circuitry, communicatively coupled to the memory, wherein the instructions, when executed by the at least one processor individually or collectively, cause the MR headset device to identify, from an MR environment, at least one object of interest and one or more physical surfaces surrounding the at least one object of interest. The instructions, when executed by the at least one processor individually or collectively, cause the MR headset device to determine user interface (UI) components associated with the at least one object of interest based on the identification information of the at least one object of interest. The instructions, when executed by the at least one processor individually or collectively, cause the MR headset device to determine, based on defined parameters, an interact-ability score for each of a plurality of regions segmented from the one or more physical surfaces, wherein the interact-ability score indicates a degree to which the each of the plurality of regions is suitable for user interaction. The instructions, when executed by the at least one processor individually or collectively, cause the MR headset device to determine a region for displaying the UI components associated with the at least one object of interest among the plurality of regions segmented from the one or more physical based on the determined interact-ability score. The instructions, when executed by the at least one processor individually or collectively, cause the MR headset device to anchor the UI components associated with the at least one object of interest to the determined region for accessing the at least one object of interest in the MR environment.

In accordance with an aspect of the disclosure, a computer-readable storage media storing one or more computer programs including computer-executable instructions that, when executed by one or more processors of a mixed reality (MR) headset device individually or collectively, cause the MR headset device to perform the method provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 depicts environments for managing user interface (UI) for accessing objects in a mixed reality (MR) environment, according to various embodiments of the disclosure;

FIG. 2 depicts a block diagram of a mixed reality (MR) headset device for managing user interface (UI) for accessing objects in an MR environment, according to an embodiment of the disclosure;

FIG. 3 depicts a logic flow diagram for managing user interface (UI) for accessing objects in a mixed reality (MR) environment, according to an embodiment of the disclosure;

FIG. 4 depicts a block diagram of objects of interest identifier of the MR headset device, according to an embodiment of the disclosure;

FIG. 5 depicts a block diagram of a cross-device state management module of the MR headset device, according to an embodiment of the disclosure,

FIG. 6A depicts a block diagram of a region segmentation module of the MR headset device, according to an embodiment of the disclosure;

FIG. 6B depicts an environment illustrating segmentation of physical surfaces into a plurality of regions, according to an embodiment of the disclosure;

FIG. 7 depicts a block diagram of an interact-ability score estimator of the MR headset device, according to an embodiment of the disclosure;

FIG. 8 depicts a block diagram of a MR UI choreographer of the MR headset device, according to an embodiment of the disclosure;

FIG. 9 depicts a block diagram of a widget composer of the MR headset device, according to an embodiment of the disclosure;

FIG. 10 depicts a block diagram of a scene generator of the MR headset device, according to an embodiment of the disclosure;

FIG. 11 depicts, by way of a flowchart, a method for managing User Interface (UI) for accessing objects in a Mixed Reality (MR) environment, according to an embodiment of the disclosure;

FIGS. 12A, 12B, 12C, 12D, and 12E depict illustrations of various use cases for managing User Interface (UI) for accessing objects in a Mixed Reality (MR) environment, according to various embodiments of the disclosure; and

FIG. 13 depicts a computer system for implementing consistent with the disclosure according to an embodiment of the disclosure.

FIGS. 14A and 14B depict illustration of various use cases for generating and anchoring XR UI widgets on physical surfaces from various applications, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises,” “comprising,” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

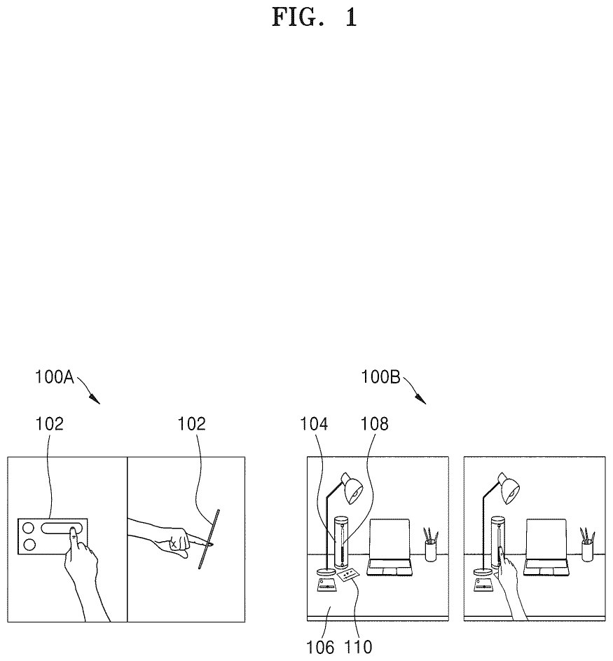

Current MR systems suffer from various drawbacks primarily due to inadequate tactile and haptic feedback and due to depth perception challenges, that make it difficult for a user to interact with UI components or UI elements in the MR environment. To overcome the above-mentioned limitations and provide additional advantages, the disclosure provides a method and a Mixed Reality (MR) headset device for UI management for accessing objects in the MR environment. In particular, the present disclosure provides a methodology for anchoring UI components onto physical surfaces in a MR environment in order to deliver tactile feedback. Further, while anchoring the UI components onto the physical surfaces, the disclosure ensures that the UI components are anchored at an optimal distance from the user in order to make user interactions with the UI components more intuitive and devoid of errors. A detailed description of the proposed solution is provided in the upcoming paragraphs in conjunction with FIGS. 1A, 1B, 2 to 5, 6A, 6B, and 7 to 11.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 depicts environments for managing UI for accessing objects in a MR environment, according to various embodiments of the disclosure.

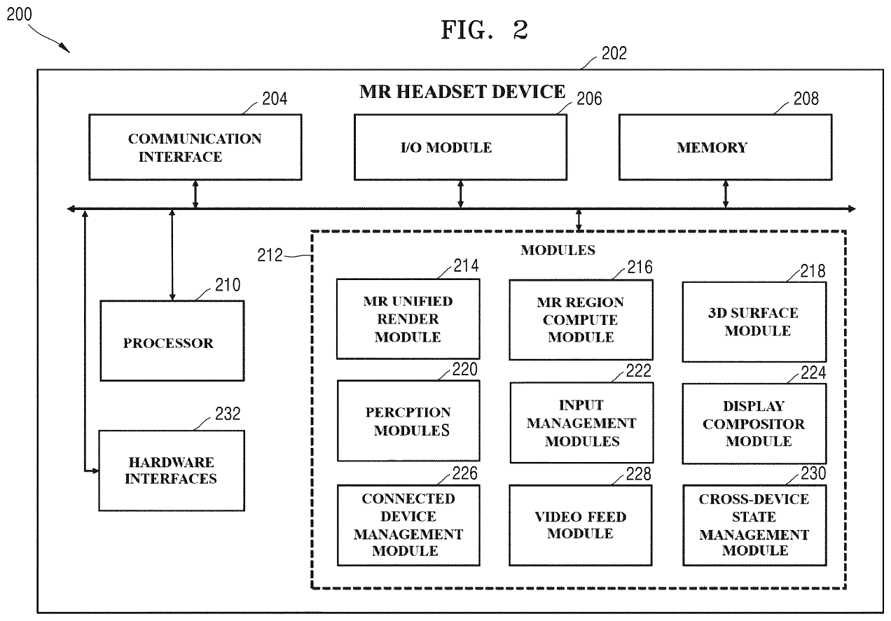

In particular, FIG. 1 depicts an environment 100A and a related MR environment 100B, where a UI panel 102 is hanging in air. A user trying to interact with the UI panel 102 faces challenges due to inadequate tactile feedback as the user's finger penetrates through the UI panel 102 that is hanging in air. In order to overcome this limitation, the disclosure describes a MR headset device that anchors UI components associated with a device (or an object of interest), such as UI component 108 and UI component 110 onto physical surfaces, such as physical surface 104 and physical surface 106 respectively, as depicted in FIG. 1B in order to allow the user to efficiently interact with the UI components 108, 110. A detailed description of the MR headset device and its functionality is provided in the upcoming paragraphs in conjunction with FIGS. 2 to 5, 6A, 6B, and 7 to 10.

FIG. 2 illustrates a block diagram of a MR headset device for managing UI for accessing objects in a MR environment, according to an embodiment of the disclosure.

Referring to FIG. 2, a block diagram 200 of an MR headset 202 is illustrated. It may be noted by a skilled person that the MR headset device 202 may be implemented in various forms including, but not limited to, a video see through (VST) device, augment reality (AR) glasses etc. In an embodiment, the MR headset device 202 (interchangeably referred to as “device 202”) comprises a communication interface 204, an input/output module (I/O) 206, memory 208, a processor 210, modules 212 and hardware interfaces 232. It shall be noted that, in an embodiment, the device 202 may include more or fewer components than those depicted herein. The various components of the device 202 may be implemented using hardware, software, firmware, or any combinations thereof. Further, the various components of the device 202 may be operably coupled with each other. More specifically, various components of the device 202 may be capable of communicating with each other using communication channel media (such as buses, interconnects, etc.).

In an embodiment, the modules 212 may comprise an MR unified render module 214, an MR region compute module 216, a 3D surface module 218, perception modules 220, input management modules 222, a display compositor module 224, a connected device management module 226, a video feed module 228 and a cross-device state management module 230. In an embodiment, the MR unified render module 214 may comprise a widget composer, a scene generator, an MR UI choreographer, and an objects of interest (OOI) identifier (not shown in FIG. 2). Further, the MR region compute module 216 may comprise an interact-ability score estimator, a region segmentation module, and a spatial anchoring module (not shown in FIG. 2). Furthermore, the 3D surface module 218 may comprise a surface texture detection module, a surface deconstruction module, a surface localization module, and a spatial compositor module (not shown in FIG. 2). Next, the cross-device state management module 230 may comprise a state synchronization module and a UI and control map module (not shown in FIG. 2).

Moving on, the perception modules 220 may comprise a plurality of modules associated with own-body detection, eye tracking, pose detection, object detection, head pose detection, depth estimation, surface identification, spatial gesture detection and environment sensing. Further, the hardware interfaces 232 may comprise interfaces associated with microphone, audio, camera, depth, tracking, motion, graphics, and display.

In an embodiment, the memory 208 is capable of storing machine executable instructions. In an embodiment, the processor 210 is embodied as an executor of software instructions. As such, the processor 210 is capable of executing the instructions stored in the memory 208 to perform one or more operations described herein.

In an embodiment, the processor 210 may be embodied as a multi-core processor, a single core processor, or a combination of one or more multi-core processors and one or more single core processors. For example, the processor 210 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

In an embodiment, the processor 210 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

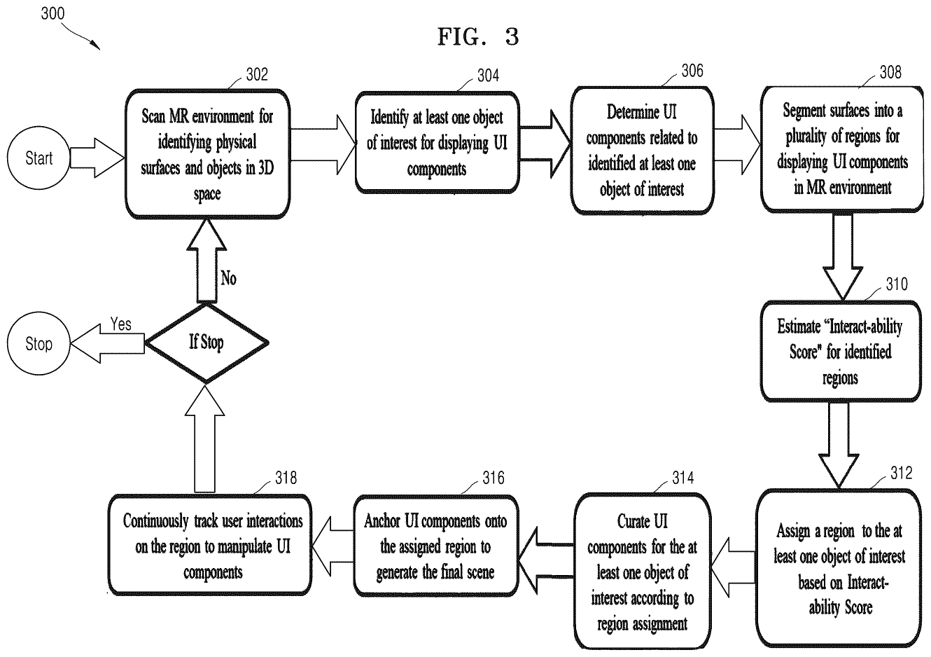

In an embodiment, the processor 210 either alone or in conjunction with the modules 212 is configured to perform various operations as depicted in the logic flow diagram 300 illustrated in FIG. 3 and elaborated in detail in the upcoming paragraphs.

FIG. 3 depicts a logic flow diagram for managing user interface (UI) for accessing objects in a mixed reality (MR) environment, according to an embodiment of the disclosure.

At block 302, the logic flow diagram 300 describes scanning a MR environment for identifying physical surfaces and objects in a 3D space. In an embodiment, the processor 210 in conjunction with the MR unified render module 214 may scan the MR environment to identify physical surfaces and a plurality of objects such as connected devices, furniture, people, etc., in the MR environment. In particular, the processor 210 in conjunction with the MR unified render module 214 may obtain image and/or point cloud data associated with the MR environment and may employ a deep learning technique to identify physical surfaces and objects. In an embodiment, for enabling the deep learning technique to identify physical surfaces and objects, a machine learning (ML) model may be trained based on a plurality of training images comprising images of MR environments to distinctly identify physical surfaces such as wall, table etc., and objects such as devices etc. The trained ML model may then be implemented in the MR environment to identify the physical surfaces and objects. Returning to FIG. 3, on identification of the physical surfaces and the plurality of objects, the logic flow diagram 300 may proceed to block 304.

At block 304, the logic flow diagram 300 describes identifying at least one object of interest for displaying UI components associated with the at least one object of interest. In an embodiment, the processor 210 in conjunction with the objects of interest identifier of the MR unified render module 214 may identify at least one object of interest amongst the plurality of objects in the MR environment.

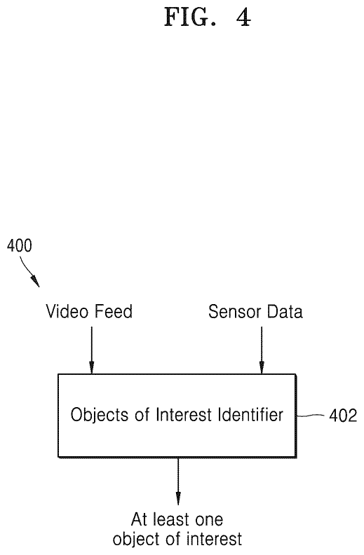

FIG. 4 depicts a block diagram of objects of interest identifier of the MR headset device, according to an embodiment of the disclosure.

In particular, FIG. 4 depicts a block diagram 400 of an objects of interest identifier 402 that takes video feed of the MR environment and combines it with data obtained from various sensors including, but not limited to, inertial sensors and depth sensors associated with the device 202 to identify from the plurality of objects, one or more objects in the field of view (FoV) of a user in the MR environment. The objects of interest identifier 402 may then, employ an object classification model to determine an object type such as connected device, remote device etc., of each of the one or more objects. Upon identifying, the one or more objects in the FoV of the user, the objects of interest identifier 402 may then identify at least one object of interest from the one or more objects based on the determined object type of the one or more objects. In an example, consider that amongst the plurality of objects present in the MR environment, the one or more objects that lie in the FoV of the user are a wall painting, a stationary holder, a laptop, and a Bluetooth speaker. In such a scenario, the objects of interest identifier 402 may identify the at least one object of interest to be the laptop and the Bluetooth speaker, based on their object type as the other objects like the wall painting and the stationary holder would not have any user interface associated with them. Returning to FIG. 3, on identifying the at least one object of interest, the logic flow diagram 300 may proceed to block 306.

At block 306, the logic flow diagram 300 describes determining UI components for the at least one object of interest. In an embodiment, the processor 210 in conjunction with the cross-device state management module 230 may determine the UI components for the at least one object of interest. In an aspect, the UI components may comprise one or more UI widgets supported by the at least one object of interest and one or more type of controls supported by each of the one or more UI widgets. In an embodiment, the one or more type of UI controls comprises at least one of: a touch control, a gesture control, and a glance control. Now, in order to determine the UI components, the processor 210 in conjunction with the cross-device state management module 230, may determine one or more connected devices associated with the at least one object of interest. For instance, if the at least one object of interest is a Bluetooth speaker, the processor 210 in conjunction with the cross-device state management module 230 may determine a mobile device to be a device connected to the Bluetooth speaker. In such a scenario, the processor 210 in conjunction with the cross-device state management module 230 may determine the UI components as the UI widgets and controls associated with a music application being executed on the mobile device through the Bluetooth speaker.

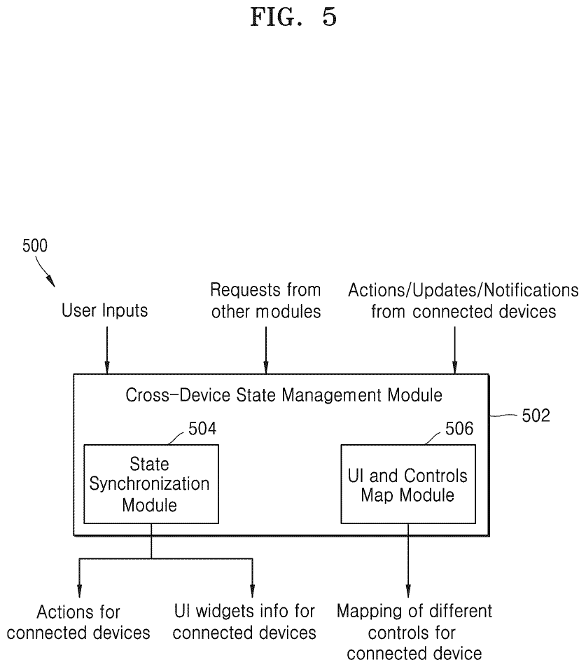

FIG. 5 depicts the cross-device state management module according to an embodiment of the disclosure.

In particular, FIG. 5 depicts a block diagram 500 of a cross-device state management module 502 comprising a state synchronization module 504 and a UI and controls map module 506. The cross-device state management module 502 takes in user inputs, actions/updates/notifications from connected devices and requests associated with the connected devices from other modules such as the MR unified render module 214. The state synchronization module 504 generates actions for one or more modules of the modules 212 in order to direct user inputs to appropriate connected device(s). The state synchronization module 504 further determines the UI widgets and controls based on current state of connected device(s). Further, the UI and controls map module 506 maps the controls to the connected device(s).

In another embodiment, in order to determine the UI components, the processor 210 in conjunction with the cross-device state management module 230, may also determine object type of the at least one object of interest. The determination of object type may help the cross-device state management module 230 to understand whether the at least one object of interest is a connected device or a remote device. For instance, the at least one object of interest may be user's television that is not connected with any other device associated with the user. In such a scenario, the UI components determined by the cross-device state management module 230 may only correspond to the television device. Returning to FIG. 3, on determining the UI components, the logic flow diagram 300 may proceed to block 308.

At block 308, the logic flow diagram 300 describes segmenting the identified physical surfaces in a plurality of regions for displaying the UI components. In an embodiment, the processor 210 in conjunction with the region segmentation module of the MR region compute module 216, may segment the identified physical surfaces into a plurality of regions.

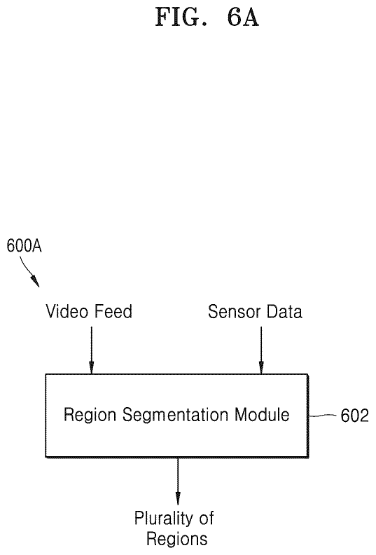

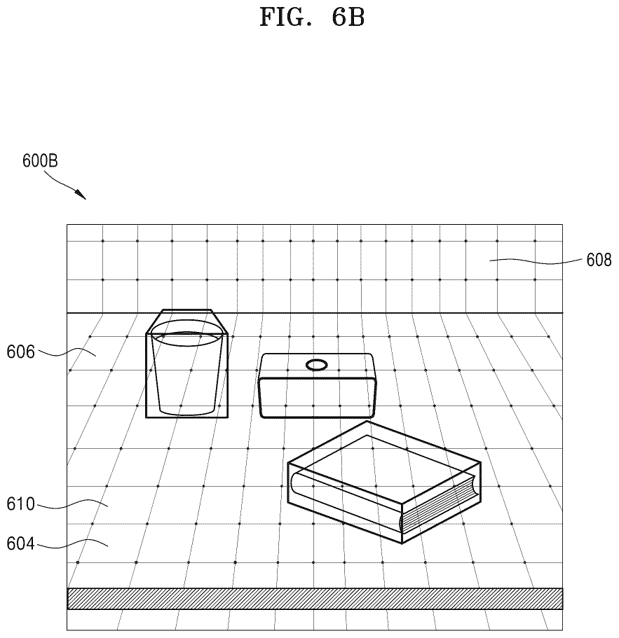

FIG. 6A depicts a block diagram of a region segmentation module according to an embodiment of the disclosure.

Referring to FIG. 6A, a block diagram 600A of a region segmentation module 602 is depicted. The region segmentation module 602 may take video feed of the MR environment and combine it with data obtained from various sensors including, but not limited to, inertial sensors and depth sensors associated with the device 202 to segment the physical surfaces in the Field of View (FoV) of a user, into a plurality of regions suitable for anchoring the UI components. In an aspect, for segmenting the physical surfaces into a plurality of regions, the processor 210 in conjunction with the region segmentation module 602 may employ one or more pre-existing region segmentation techniques based on one of: region growing, region splitting and region splitting and merging, such that a size of each region is greater than a predefined threshold in order to suitably allow the UI components to be anchored onto the regions. For instance, the predefined threshold may be set to be 100 cm² in order to accommodate the UI components on a region suitably. However, it may be appreciated that the predefined threshold described herein is representative and the predefined threshold may have a different value depending upon the object of interest and the UI components associated with it. Returning to FIG. 3, on segmenting the physical surfaces into the plurality of regions, the logic flow diagram 300 may proceed to block 310.

At block 310, the logic flow diagram 300 describes determining an interact-ability score for each of the plurality of regions. In an embodiment, the processor 210 in conjunction with the interact-ability score estimator of the MR region compute module 216, may determine the interact-ability score for each of the plurality of regions. In an embodiment, the interact-ability score associated with the each of the plurality of regions may be a score representing how good/suitable a region of a physical surface is for user interactions.

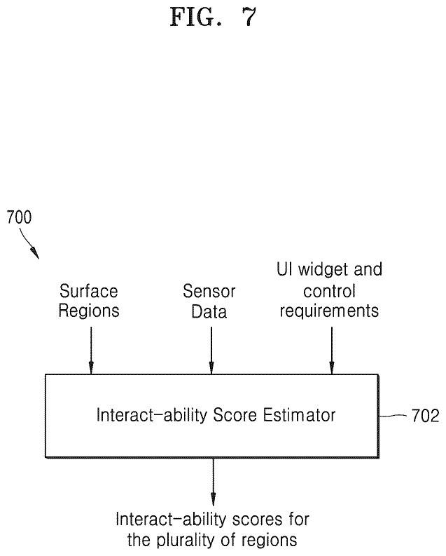

FIG. 7 depicts a block diagram 700 of an interact-ability score estimator 702 according to an embodiment of the disclosure.

In an embodiment, the interact-ability score estimator 702 may take as inputs the regions of physical surfaces including region boundaries and image bitmap, sensor data, UI widgets and controls' requirements. The interact-ability score estimator 702 may employ a machine learning model to identify the predefined parameters necessary for determining the interact-ability score. In an aspect, the predefined parameters may include, but not limited to, surface parameters associated with surface texture information, surface geometry information and surface localization information for each of the plurality of regions. For instance, the surface parameters may include, but not limited to, surface texture, surface reflexivity, surface flatness, surface material, surface contrast, size of a region, distance of a region from a user, distance from the edges and angle of interaction. Further, the predefined parameters may also be associated with user preferences and may include, but not limited to, user handedness and friction preference. In an embodiment, the user preferences may be learned. In particular, by learning user preferences for spatial interactions, the XR user interface (XR UI) may be dynamically curated and updated based on how the user prefers to interact with the UI in the XR environment. The learning of user preferences may be performed based on interaction patterns, user handedness, friction preference, and other interaction-related data, thereby allowing the user to experience an XR UI that is optimized for their individual usage environment. Moreover, the user preferences may include a user context. In an embodiment, the user context may be at least one of a field of view, reachability, or vicinity associated with the user. Moving on, the predefined parameters may also be associated with the object of interest and may include, but not limited to, distance of a region from the object of interest, orientation of a region with respect to the object of interest, size of the object of interest and a spatial context of the object of interest. In an embodiment, the spatial context may be localization and spatial relationship of various objects in the XR scene, e.g., connected devices, accessories, props etc. Furthermore, the predefined parameters may also be associated with the type of UI controls and a size requirement of the UI widgets. Upon estimating the predefined parameters, the interact-ability score estimator 702 may determine the interact-ability score for each of the plurality of regions. In an embodiment, the interact-ability score estimator 702 may output an optimal region out of the plurality of regions that is most suitable for anchoring the UI components. In an embodiment, the interact-ability score estimator 702 may assign an interact-ability score value to each of the plurality of regions (illustrated in FIG. 6B) as depicted in a Table 1 below.

TABLE 1
Interact-ability score determination

| | | | Region 1 | | Region 2 | | Region 3 | | Region 4 | |
|---|---|---|---|---|---|---|---|---|---|---|
| Parameters | | | 604 | | 606 | | 608 | | 610 | |
| Surface | Surface | Flatness | Flat | | Flat | | Curved | | Irregular | |
| Properties | Properties | (Flat/Curved/Irregular) | | | | | | | | |
| | | Texture | Smooth | | Smooth | | Rough | | Rough | |
| | | (Rough/Smooth) | | | | | | | | |
| | | Reflexivity | Matt | | Matt | | Glare | | Glare | |
| | | (Matt/Glare) | | | | | | | | |
| | | Material (Solid/Fluid) | Solid | | Solid | | Fluid | | Solid | |
| | Visual | Contrast (High/Low) | Low | | Low | | High | | High | |
| | Properties | Reflexivity | Matt | | Matt | | Glossy | | Glossy | |
| | | (Matt/Glossy) | | | | | | | | |
| | Geometric | Distance from user | 50 | cm | 70 | cm | 100 | cm | 85 | cm |
| | Properties | Distance from Edges | 10 | cm | 15 | cm | 150 | cm | 250 | cm |
| | | Size of the region | 200 | sq. cm | 100 | sq. cm | 150 | sq. cm | 300 | sq. cm |
| | | Angle Of Interaction | 45° | | 70° | | 80° | | 75° | |
| | User | Handedness | 10 | cm | 15 | cm | 25 | cm | 20 | cm |
| | Preferences | (Right/Left) | | | | | | | | |
| | | Friction preference | Low | | Low | | High | | Medium | |
| | | (Low/Medium/High) | | | | | | | | |
| Object Of | Proximity | Distance from Object of | 30 | cm | 20 | cm | 100 | cm | 100 | cm |
| Interest | | Interest | | | | | | | | |
| | Orientation | Region orientation w.r.t | 0° | | 30° | | 45° | | 40° | |
| | | OOI | | | | | | | | |
| | Size | Size of the Object Of | 100 | cm³ | 200 | cm³ | 50 | cm³ | 500 | cm³ |
| | | interest | | | | | | | | |
| Widget | UI | [Touch/Gesture/Glance] | Touch | | Touch | | Glance | | Touch | |
| Requirements | Controls | | | | | | | | | |
| | Widget | Minimum Size | 50 | sq. cm | 50 | sq. cm | 50 | sq. cm | 100 | sq. cm |

| | | | | |
|---|---|---|---|---|
| Interact-ability score | 0.9 | 0.8 | 0.1 | 0.3 |

Referring to FIG. 6B, an environment 600B illustrating segmentation of physical surfaces into a plurality of regions, is depicted according to an embodiment of the disclosure. Table 1 above depicts an interact-ability score determination for regions 604-610 based on the plurality of predefined parameters. It may be appreciated by a skilled that the form in which the interact-ability score is depicted in Table 1 is representative and the interact-ability score can have a numerical value in the form of a whole number or a decimal. Further, the interact-ability score can also be determined in the form of a grade. Returning to FIG. 3, on determining the interact-ability score for each of the plurality of regions, the logic flow diagram may proceed to block 312.

At block 312, the logic flow diagram 300 describes assigning (e.g., determining) a region to the at least one object of interest based on the determined interact-ability score. In an embodiment, the processor 210 in conjunction with the MR UI choreographer MR region compute module 216, may assign a region to the at least one object of interest.

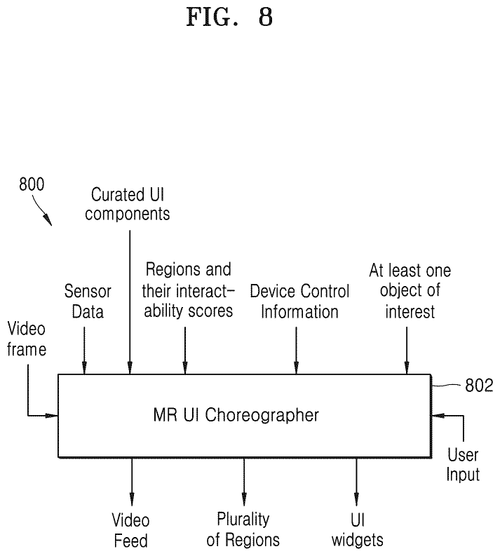

FIG. 8 depicts a block diagram of a MR UI choreographer according to an embodiment of the disclosure.

The MR UI choreographer 802 of block diagram 800 performs various tasks, one of the tasks being assigning a region to the at least one object of interest. The MR UI choreographer 802 takes inputs from various other modules. For the task of region assignment, the MR UI choreographer 802 takes information about the at least one object of interest from the objects of interest identifier 402. It further takes information regarding the plurality of regions from the region segmentation module 602 and receives the interact-ability score for each of the plurality of regions from the interact-ability score estimator 702. The MR UI choreographer 802 takes video frame, sensor data, curated UI components, and device control information. Upon receiving the inputs, the processor 210 in conjunction with the MR UI choreographer 802 may analyse each region to examine its reachability from the user and its spatial orientation in conjunction with its interact-ability score. For said analysis, the MR UI chorographer 802 may employ a machine learning model that is trained for the specific task. Further, the processor 216 in conjunction with the MR region compute module 216 may assign a region to the at least one object of interest that is most suitable for anchoring the UI components. For instance, there may be two regions with the same interact-ability score, in such a scenario, the MR UI choreographer 802 may determine which region is more easily accessible to the user and may assign that region to the at least one object of interest. In particular, say the user in question is left-handed, and a region situated towards the left of the user would be assigned to the at least one object of interest than another region, with the same interact-ability score that is situated towards the right of the user. Returning to FIG. 3, on assigning a respective region to the at least one object of interest, the logic flow diagram 300 may proceed to block 314.

At block 314, the logic flow diagram 300 describes curating the UI components for the at least one object of interest according to region assignment. In an embodiment, the processor 210 in conjunction with the widget composer of the MR unified render module 214 may curate one or more UI widgets and the one or more controls.

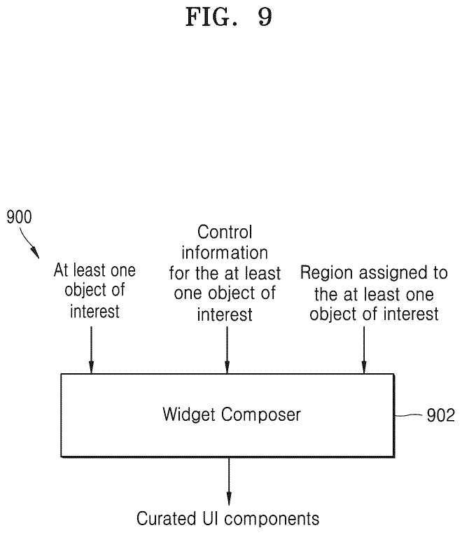

FIG. 9 depicts a block diagram of a widget composer according to an embodiment of the disclosure.

In an embodiment, the widget composer 902 of block diagram 900 may take as inputs information associated with: the at least one object of interest, UI controls for the at least object of interest and the region assigned to the at least one object of interest. The processor 210 in conjunction with the widget composer 902 may identify a minimum area requirement for displaying the UI components associated with the at least one object of interest. In an embodiment, the minimum area requirement may be set based on the UI components associated with the at least one object of interest. For instance, if the at least one object of interest is an air conditioner, then the UI components may include controls associated with temperature up and down along with power on and off. Such UI components would require lesser area on a region in comparison to the UI components for a Bluetooth speaker that is connected to a mobile device and executing a music application. Hence, it becomes critical to identify the minimum area requirement by taking into consideration the object of interest and the UI components associated with it. Thereafter, the processor 210 in conjunction with the widget composer 902 may then identify one or more UI widget templates satisfying the minimum area requirement. In an embodiment, if there are multiple possible widget templates that satisfy minimum area requirement, the processor 210 in conjunction with the widget composer 902 may select the UI widget template with the largest area as it may give the most control to the user in a MR scene. For instance, if the minim area requirement was 50 cm², and there are three UI widget templates with corresponding areas as 50 cm², 125 cm² and 150 cm². The processor 210 in conjunction with the widget composer shall select the third Ui widget template having the largest area of 150 cm² in order to give maximum control to the user in the MR scene. Finally, upon selecting the UI widget template, the processor 210 in conjunction with the widget composer 902 may modify or curate the UI widget template to include the UI components associated with the at least one object of interest so as to fill the controls in the UI widget template based on user preferences and the supported features of the at least one object of interest. Returning to FIG. 3, on curating the UI components, the logic flow diagram 300 may proceed to block 316.

At block 316, the logic flow diagram 300 describes anchoring the UI components onto the assigned region to generate the final scene. In an embodiment, the processor 210 in conjunction with the MR UI choreographer 802 of the MR region compute module 216 may anchor the UI components onto the assigned region. As described in the preceding paragraphs, the MR UI choreographer 802 performs various tasks. One of the tasks was assigning a region to the at least one object of interest. Now, for anchoring the curated UI components onto the assigned region, the MR UI choreographer 802 receives as input the curated UI components from the widget composer 902 and the device control information associated with the at least one object of interest from the cross-device state management module 230. The processor 210 in conjunction with the MR UI choreographer 802 may then anchor the UI components on the assigned region in 3D space using Advanced Computer Vision (ACV) and spatial mapping techniques within the MR environment. Upon anchoring the UI components, the video feed of the MR environment, along with the information associated with the plurality of regions and the anchored UI components is passed onto the scene generator of the MR unified render module 214 to generate a final scene that can be visible to the user.

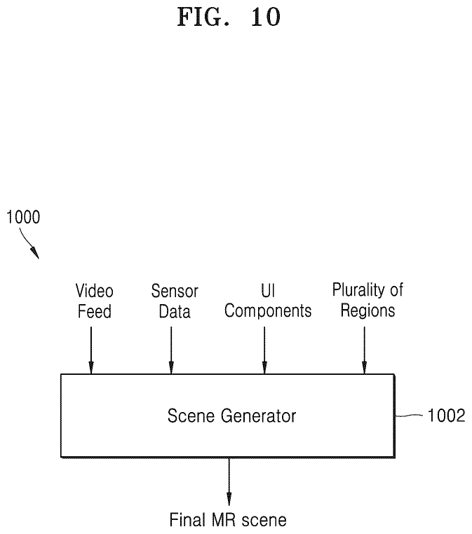

FIG. 10 depicts a block diagram of a scene generator according to an embodiment of the disclosure.

The scene generator 1002 of block diagram 1000 takes as inputs the video feed, data obtained from various sensors including, but not limited to, inertial sensors and depth sensors associated with the device 202, information associated with the anchored UI components, and the plurality of regions. Upon receiving the inputs, the processor 210 in conjunction with the scene generator 1002 composes and merges different layers of the MR environment (that is, the anchored UI components and real world (as obtained from the Video feed)) in order to generate and display the final MR scene to the user. The final MR scene displayed to the user includes the curated UI components associated with the at least one object of interest anchored on a region in the 3D space, where the user can easily access the at least one object of interest by interacting with the anchored UI components. Returning to FIG. 3, on generating the final MR scene and displaying the same to user, the logic flow diagram 300 may proceed to block 318.

At block 318, the logic flow diagram 300 describes continuously tracking interactions of the user on the region assigned to the respective object of interest for manipulating the UI components. For instance, considering the example where the at least one object of interest is a Bluetooth speaker, the anchored and curated UI components may correspond to a music application being executed on a mobile device and played through the Bluetooth speaker. The UI components may depict a current song being played and controls associated with forward and rewind, volume up or down etc. Now, the user may switch to another application on the mobile device, in such a scenario, the UI components may need to be manipulated. To tackle this, the MR UI choreographer 802 continuously tracks the interactions of the user on the assigned region and manipulates the UI components accordingly. In particular, upon identifying that the user has switched from the current music application to say, another music application, the MR UI choreographer 802 may manipulate the UI components in order to correspond to the switched music application, thereby providing the user with a comfortable and interactive experience while accessing the at least one object of interest.

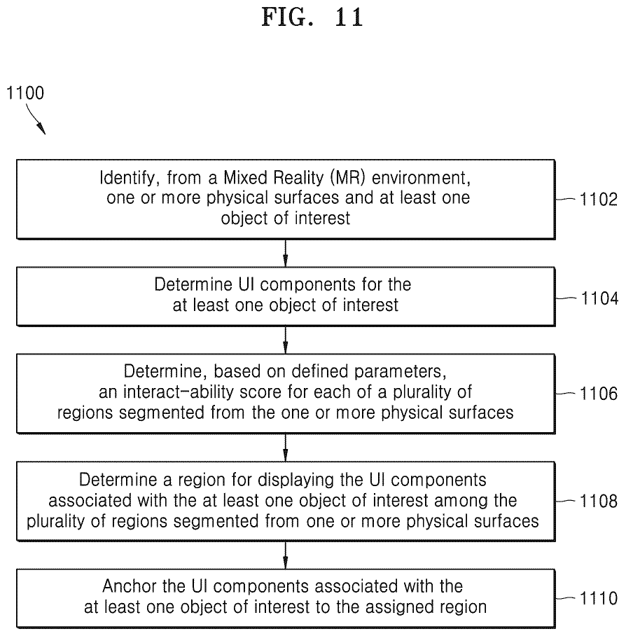

FIG. 11 is a flowchart showing a method for managing user interface (UI) for accessing objects in a mixed reality (MR) environment according to an embodiment of the disclosure.

The method 1100 may comprise one or more operations. The method 1100 may be described in the general context of computer executable instructions. Generally, computer executable instructions can include routines, programs, objects, components, data structures, procedures, modules, and functions, which perform particular functions or implement particular abstract data types.

Further, the order in which the method 1100 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At operation 1102, the method 1100 may include identifying, from a MR environment, one or more physical surfaces and at least one object of interest for displaying a UI associated with the at least one object of interest. In an embodiment, for said identifying the MR environment the processor 210 in conjunction with the MR unified render module 214 may be utilized. In particular, images and/or point cloud data captured by various sensors may be analysed by the processor 210 in conjunction with the MR unified render module 214 to identify the physical surfaces and the objects in the MR environment. Further, upon identifying the objects in the MR environment, the method may further include identifying the at least one object of interest from the identified objects. To achieve this, the processor 210 in conjunction with the objects of interest identifier 402 may be utilized.

At operation 1104, the method 1100 may include determining UI components for the at least one object of interest based on the identification information of the at least one object of interest. In an embodiment, the processor 210 in conjunction with the cross-device state management module 230 may determine the UI components for the at least one object of interest. In an aspect, the UI components may comprise one or more UI widgets supported by the at least one object of interest and one or more type of controls supported by each of the one or more UI widgets. For example, when an object of interest is smartwatch, the cross-device state management module 230 may determine the UI components including playback buttons, playlist widgets, and volume controls. When an object of interest is air conditioner, the cross-device state management module 230 may determine the UI components including power on/off, temperature control, cooling modes. The method 1100 may include determining UI components for the at least one object of interest based on at least one of: an object type and one or more devices connected with a respective object of interest. In an embodiment, the object type of the at least one object of interest may be connected device, remote device, furniture, etc. In an embodiment, the one or more devices connected of the at least one object of interest may be a mobile device connected to a Bluetooth speaker.

At operation 1106, the method 1100 may include determining, based on predefined parameters, an interact-ability score for each of a plurality of regions segmented from the one or more physical surfaces. In an embodiment, prior to determining the interact-ability score, the method 1100 may include segmenting each of the one or physical surfaces into a plurality of regions. It may be noted by a skilled person that for said segmenting, the processor 210 in conjunction with the region segmentation module 602 may implement one or more pre-existing region segmentation techniques such that each segmented region has a size greater than a predefined threshold. Further, upon segmenting each of the one or more physical surfaces, the processor 210 in conjunction with the interact-ability score estimator 702 may calculate the interact-ability score for each of the plurality of regions based on the predefined parameters associated with surface properties, user preferences, object of interest, etc.

At operation 1108, the method 1100 may include assigning a region to each object of interest based at least on the determined interact-ability score, user context and spatial context. In an embodiment, the processor 210 in conjunction with the MR UI choreographer MR region compute module 216, may be utilized for assigning a region to each object of interest.

At operation 1110, the method 1100 may include anchoring the UI components associated with the respective object of interest to the assigned region for accessing the respective object of interest in the MR environment. In an embodiment, before anchoring the UI components, the method 1100 may also include curating the UI components for the at least one object of interest according to region assignment. For curating the UI components, the processor 210 in conjunction with the widget composer 902 may select a UI widget template that fits well onto the assigned region and then modify the UI widget template to include the UI components based on user preferences and features supported by the at least one object of interest. Upon curating the UI components, the processor 210 in conjunction with the MR UI choreographer 802 of the MR region compute module 216 may be utilized for anchoring the UI components onto the assigned region.

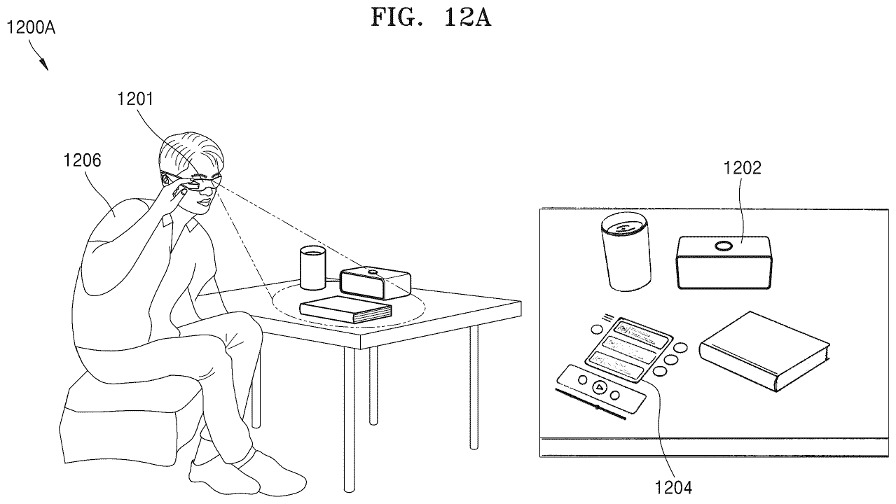

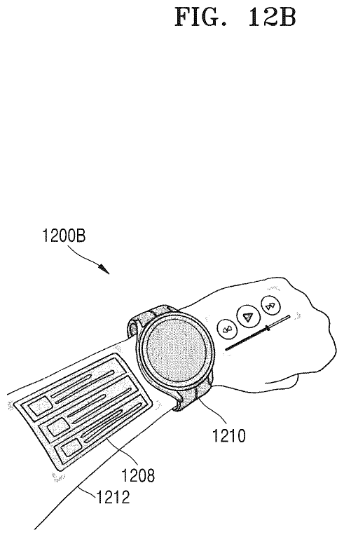

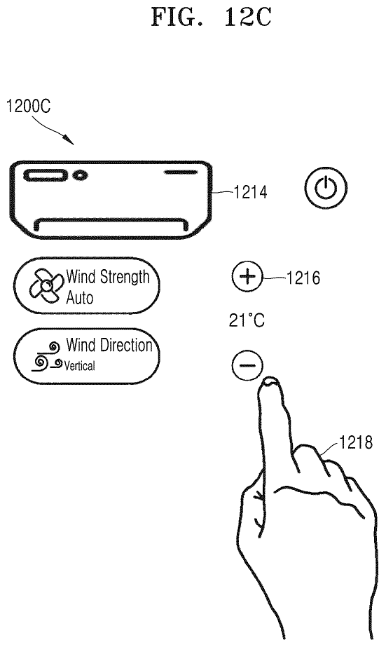

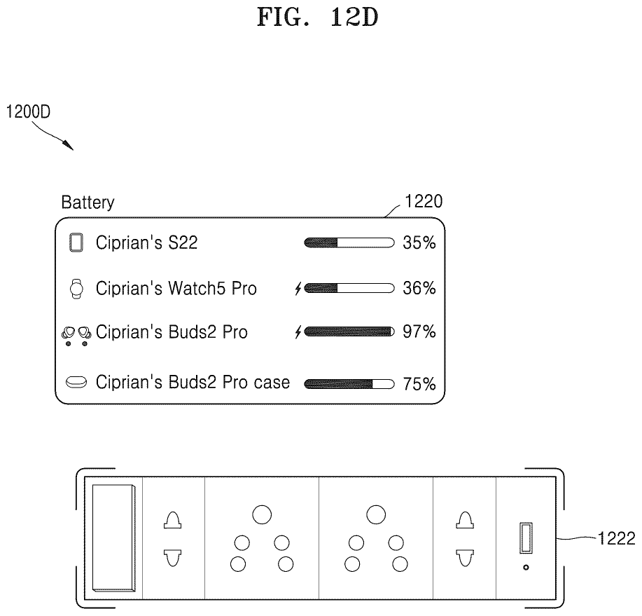

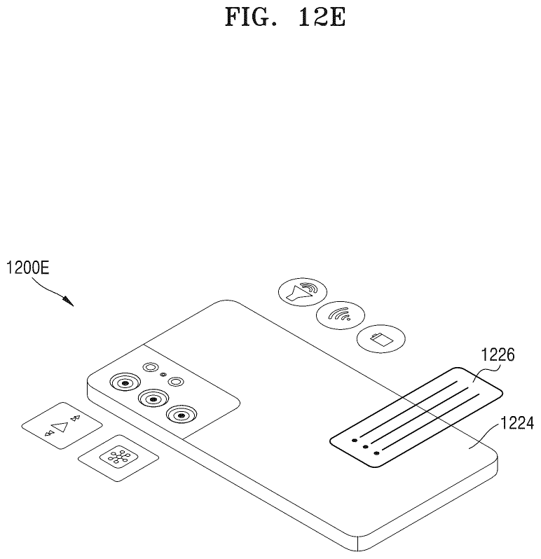

FIGS. 12A to 12D depict illustrations of various use cases for managing user interface (UI) for accessing objects in a mixed reality (MR) environment, according to various embodiments of the disclosure.

It may further be appreciated by a skilled person that the technique of the disclosure can be applied to various use cases. Some of the use cases are depicted in FIGS. 12A to 12D. In an embodiment, an environment 1200A illustrating applying control interface 1204 for connected devices such as device 1202 in close proximity to a user 1206 wearing an XR headset device 1201, is depicted in FIG. 12A. For instance, the XR headset device 1201 detects connected device 1202 present in the physical environment and maps the physical space around the connected device 1202 with respect to user orientation. During this mapping process, both the available surface areas around the connected device 1202 and any obstructions located between the user 1206 and the connected device 1202 are analyzed to identify optimal regions for placing the relevant device controls. Once the physical space around the detected device 1202 has been mapped, the XR headset device 1201 places the control interface 1204 for the connected device 1202 in alignment with the connected device 1202 and the clutter present in the physical environment. This spatial alignment allows the control interface 1204 to be naturally positioned in the user's field of view, ensuring that the control elements avoid overlapping with obstacles or other unrelated objects, which enhances clarity and interaction stability.

In an embodiment, an environment 1200B illustrating augmenting the controls of a connected device on a designated area in proximity to the connected device as depicted in FIG. 12B. In particular, FIG. 12B depicts control interface 1208 associated with a smart watch 1210 being augmented on user's arm 1212 and hence, user's feedback can easily be recorded when he/she touches the designated area on the arm. In an embodiment, an environment 1200C illustrating identifying and apply controls 1216 for connected home devices, such as an air conditioner 1214 in close proximity to a user 1218, is illustrated in FIG. 12C. In an embodiment, an environment 1200D illustrating identifying and apply contextual device information to related objects in close proximity to the device, is depicted in FIG. 12D. For instance, as depicted in FIG. 12D, battery levels 1220 of various connected devices such as smart watch, earbuds etc., may be displayed in proximity to a plug point (object of interest) 1222 in the 3D space. On similar lines, information related to air quality index (AQI) and weather may be displayed in close proximity to the air purifier (object of interest).

In an embodiment, an environment 1200E illustrating augmenting the controls of a connected device on a designated area in proximity to the connected device, is depicted in FIG. 12E. In particular, FIG. 12E depicts control interface 1226 associated with a smartphone 1224 being augmented onto or back surface of the smartphone 1224 placed in proximity to the user and hence, user can touch the surface where controls are augmented.

It may also be appreciated by a skilled person that the use cases described herein are representative and should not be construed as limiting.

### Computer System

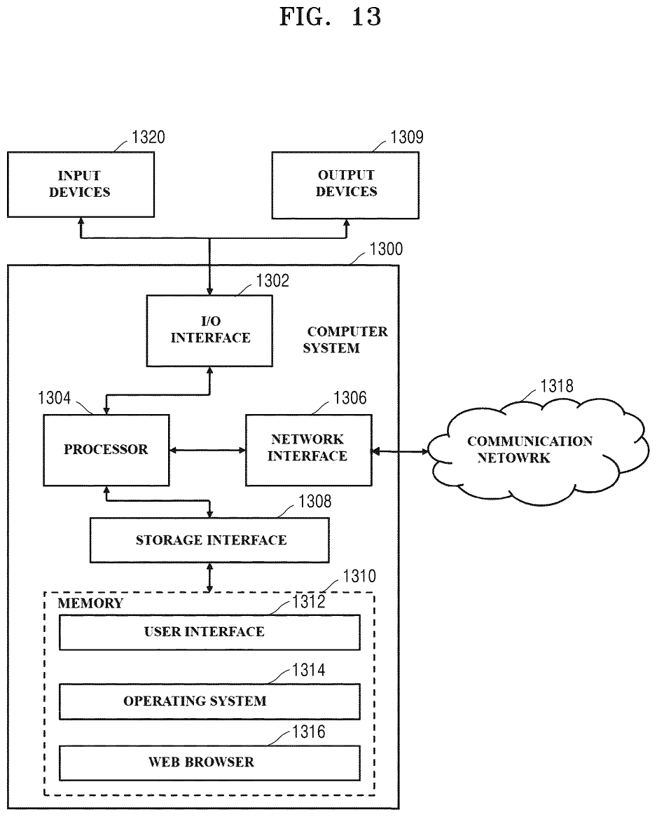

FIG. 13 illustrates a block diagram of a computer system for implementing embodiments consistent with the disclosure according to an embodiment of the disclosure.

In an embodiment, the computer system 1300 may be used to implement the MR headset device 202. Thus, the computer system 1300 may be used for fault detection in electro-mechanical panels. The computer system 1300 may comprise a central processing unit 1304 (also referred as “CPU” or “processor”). The processor 1304 may comprise at least one data processor. The processor 1304 may include specialized processing units such as integrated system (bus) controllers, memory management control units, floating point units, graphics processing units, digital signal processing units, etc.

The processor 1304 may be disposed in communication with one or more input/output (I/O) devices (not shown) via I/O interface 1302. The I/O interface 1302 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), radio frequency (RF) antennas, S-Video, VGA, IEEE 1016.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 1302, the computer system 1300 may communicate with one or more I/O devices. For example, the input device 1320 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 1309 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 1304 may be disposed in communication with the communication network 1318 via a network interface 1306. The network interface 1306 may communicate with the communication network 1318. The network interface 1306 may employ connection protocols including, without limitation, direct connect, Ethernet (e.g., twisted pair 10/100/1000 Base T), transmission control protocol/internet protocol (TCP/IP), token ring, IEEE 1016.11a/b/g/n/x, etc. The communication network 1318 may include, without limitation, a direct interconnection, local area network (LAN), wide area network (WAN), wireless network (e.g., using wireless application protocol), the Internet, etc. The network interface 1306 may employ connection protocols include, but not limited to, direct connect, ethernet (e.g., twisted pair 10/100/1000 Base T), transmission control protocol/internet protocol (TCP/IP), token ring, IEEE 1016.11a/b/g/n/x, etc.

The communication network 1318 includes, but is not limited to, a direct interconnection, an e-commerce network, a peer to peer (P2P) network, local area network (LAN), wide area network (WAN), wireless network (e.g., using wireless application protocol), the Internet, Wi-Fi, and such. The first network and the second network may either be a dedicated network or a shared network, which represents an association of the different types of networks that use a variety of protocols, for example, hypertext transfer protocol (HTTP), transmission control protocol/internet protocol (TCP/IP), wireless application protocol (WAP), etc., to communicate with each other. Further, the first network and the second network may include a variety of network devices, including routers, bridges, servers, computing devices, storage devices, etc. The communication network 1318 may be in communication with the plurality of sensors 104 to monitor vibrations.

In an embodiment, the processor 1304 may be disposed in communication with memory 1310 (e.g., RAM, ROM, etc. not shown in FIG. 13) via a storage interface 1308. The storage interface 1308 may connect to memory 1310 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 1310 may store a collection of program or database components, including, without limitation, user interface 1312, an operating system 1314, web browser 1316 etc. In an embodiment, computer system 1300 may store user/application data, such as, the data, variables, records, etc., as described in this disclosure. Such databases may be implemented as fault-tolerant, relational, scalable, secure databases such as Oracle® or Sybase®.

The operating system 1314 may facilitate resource management and operation of the computer system 1300. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™ UBUNTU™, KUBUNTU™, etc.), IBM™ OS/2, MICROSOFT™ WINDOWS™ (XP™, VISTA™/7/8, 10 etc.), APPLE® IOS™, GOOGLER ANDROID™, BLACKBERRY® OS, or the like.

In an embodiment, the computer system 1300 may implement the web browser 1316 stored program component. The web browser 1316 may be a hypertext viewing application, for example MICROSOFT® INTERNET EXPLORER™ GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 1316 may utilize facilities such as AJAX™, DHTML™, ADOBE® FLASH™, JAVASCRIPT™, JAVA™, Application Programming Interfaces (APIs), etc. In some embodiments, the computer system 1300 may implement a mail server (not shown in FIG. 13) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as internet message access protocol (IMAP), messaging application programming (MAPI), MICROSOFT® exchange, post office protocol (POP), simple mail transfer protocol (SMTP), or the like. In some embodiments, the computer system 1300 may implement a mail client stored program component. The mail client (not shown in FIG. 13) may be a mail viewing application, such as APPLE® MAIL™, MICROSOFT® ENTOURAGE™, MICROSOFT® OUTLOOK™, MOZILLA® THUNDERBIRD™ etc.

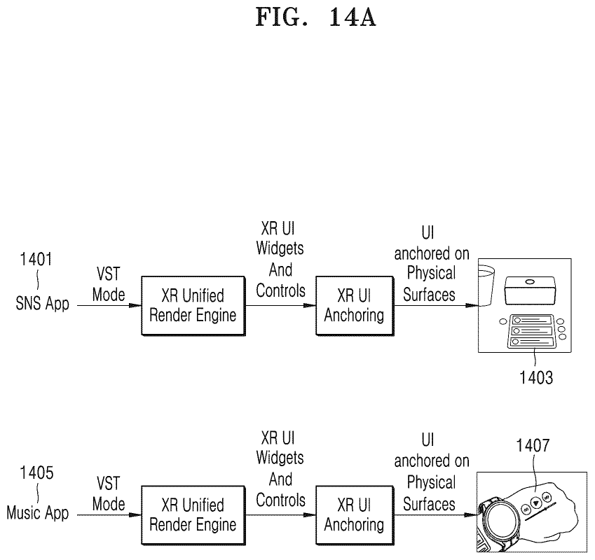

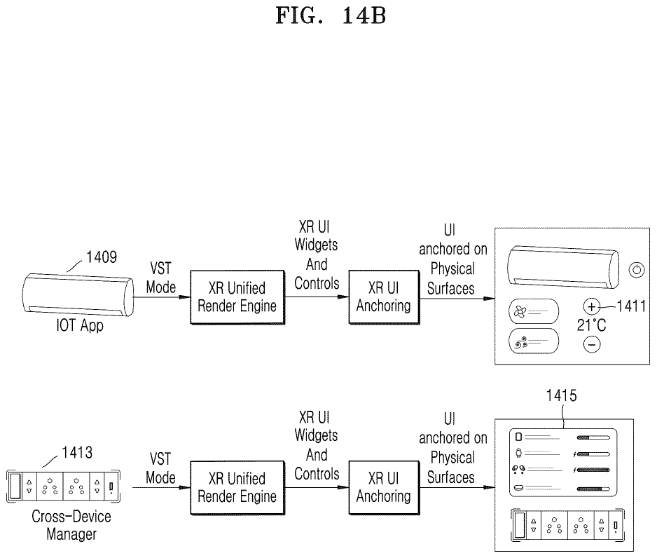

FIGS. 14A and 14B depict illustration of various use cases for generating and anchoring XR UI widgets on physical surfaces from various applications, according to an embodiment of the disclosure.

For example, when a Social Network Service (SNS) application 1401 is executed, the XR Unified Render Engine parses the data received from the SNS application 1401 and generates corresponding XR UI widgets and controls 1403, which are subsequently anchored on suitable physical surfaces within the user's environment. As a result, the user can access social media interactions such as messaging, notifications, and media sharing without any manual arrangement of the UI widgets and controls 1403.

When a music application 1405 is executed, the XR Unified Render Engine similarly generates music control interfaces 1407 including playback buttons, playlist widgets, and volume controls. These control interfaces 1407 are placed on physical surfaces near the user, such as on or around connected smartwatches or smartphones, enabling intuitive interaction without disrupting the spatial environment.

When an Internet of Things (IoT) application 1409 is executed, the XR Unified Render Engine generates UI widgets and controls 1411 specific to home appliances, such as air conditioners or lighting systems, and places these controls in proximity to the corresponding physical devices, thereby simplifying the management of such devices in the XR space.

When a Cross-Device Manager 1413 is invoked, the XR Unified Render Engine creates a unified UI widgets and controls 1415 for multiple connected devices, such as smart power strips or hubs, and anchors the UI widgets and controls 1415 onto a physical surface near the devices, allowing the user to efficiently monitor and control multiple devices through a single XR UI panel.

The XR Unified Render Engine can be updated to support XR UI widgets and controls curation for future connected devices.

The illustrated steps are set out to explain an embodiment shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices. The functionality and/or the features of a device may be alternatively embodied by one or more other devices which are not explicitly described as having such functionality/features. Thus, other embodiments of the disclosure need not include the device itself.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

In an embodiment, the technique of the disclosure enables users to feel the physical surface while interacting with virtual controls, providing immediate and natural tactile feedback that boosts interaction accuracy and user confidence.

In an embodiment, the technique of the disclosure ensures that the UI components are placed at an optimal distance from the user anchored to physical surfaces based on the spatial context. This improves depth perception, making interactions more intuitive and reduces errors during interactions.

In an embodiment, by anchoring the UI components to physical surfaces in the MR environment, the technique of the disclosure can alleviate physical fatigue caused by prolonged use of MR interfaces.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

The specific examples provided to explain the embodiments according to the present disclosure are merely a combination of each standard, method, detail method, and operation, and the various embodiments described herein can be performed through a combination of at least two or more techniques among the various techniques described. In addition, at this time, it can be performed according to a method determined through a combination of one or at least two or more of the aforementioned techniques. For example, it may be possible to perform a combination of parts of the operation of one embodiment with parts of the operation of another embodiment.

In an embodiment, a method performed by a mixed reality (MR) headset device is provided. The method includes identifying, from an MR environment, at least one object of interest and one or more physical surfaces surrounding the at least one object of interest. The method includes determining user interface (UI) components associated with the at least one object of interest based on the identification information of the at least one object of interest. The method includes determining, based on defined parameters, an interact-ability score for each of a plurality of regions segmented from the one or more physical surfaces, the interact-ability score indicates a degree to which the each of the plurality of regions is suitable for user interaction. The method includes determining a region for displaying the UI components associated with the at least one object of interest among the plurality of regions segmented from the one or more physical surfaces based on the determined interact-ability score, and the method includes anchoring the UI components associated with the at least one object of interest to the determined region for accessing the at least one object of interest in the MR environment.

In an embodiment, the method includes generating a final scene corresponding to the MR environment upon the anchoring the UI components.

In an embodiment, the method includes continuously tracking interactions of a user with the UI components anchored to the determined region for manipulating the UI components.

In an embodiment, the identifying of the at least one object of interest comprises identifying, from a plurality of objects, one or more objects in a field of view (FOV) of a user present in the MR environment. In an embodiment, the identifying of the at least one object of interest comprises determining, using an object classification model, an object type of the one or more objects. In an embodiment, the identifying of the at least one object of interest comprises identifying, from the one or more objects, the at least one object of interest based on the object type of the one or more objects.

In an embodiment, the determining of the UI components comprises determining one or more UI widgets supported by the at least one object of interest. In an embodiment, the determining of the UI components comprises determining one or more type of UI controls supported by the one or more UI widgets, wherein the one or more type of UI controls comprises at least one of a touch control, a gesture control, and a glance control.

In an embodiment, the one or more physical surfaces are segmented into the plurality of regions by employing one or more defined region segmentation techniques. In an embodiment, the plurality of regions have a size greater than a defined threshold.

In an embodiment, the defined parameters comprise at least one of surface texture information, surface geometry information and surface localization information for the plurality of regions. In an embodiment, the defined parameters comprise user preferences associated with a user. In an embodiment, the defined parameters comprise a distance from the at least one object of interest and an orientation with respect to the at least one object of interest. In an embodiment, the defined parameters comprise spatial context of the object of interest. In an embodiment, the defined parameters comprise a dimension of the at least one object of interest. In an embodiment, the defined parameters comprise a size requirement for one or more UI widgets. In an embodiment, the defined parameters comprise a type of control supported by the one or more UI widgets.

In an embodiment, the method includes identifying a minimum area requirement for displaying the UI components associated with the at least one object of interest. In an embodiment, the method includes identifying one or more UI widget templates satisfying the minimum area requirement. In an embodiment, the method includes modifying the one or more UI widget templates to include the UI components associated with the corresponding at least one object of interest.

In accordance with an aspect of the disclosure, a mixed reality (MR) headset device is provided. The MR headset device includes memory, comprising one or more storage media, storing instructions. The MR headset device includes at least one processor comprising processing circuitry, communicatively coupled to the memory, wherein the instructions, when executed by the at least one processor individually or collectively, cause the MR headset device to identify, from an MR environment, at least one object of interest and one or more physical surfaces surrounding the at least one object of interest. The instructions, when executed by the at least one processor individually or collectively, cause the MR headset device to determine user interface (UI) components associated with the at least one object of interest based on the identification information of the at least one object of interest. The instructions, when executed by the at least one processor individually or collectively, cause the MR headset device to determine, based on defined parameters, an interact-ability score for each of a plurality of regions segmented from the one or more physical surfaces, wherein the interact-ability score indicates a degree to which the each of the plurality of regions is suitable for user interaction. The instructions, when executed by the at least one processor individually or collectively, cause the MR headset device to determine a region for displaying the UI components associated with the at least one object of interest among the plurality of regions segmented from the one or more physical based on the determined interact-ability score. The instructions, when executed by the at least one processor individually or collectively, cause the MR headset device to anchor the UI components associated with the at least one object of interest to the determined region for accessing the at least one object of interest in the MR environment.

In an embodiment, the instructions, when executed by the at least one processor individually or collectively, cause the MR headset device to generate a final scene corresponding to the MR environment upon the anchoring the UI components.

In an embodiment, the instructions, when executed by the at least one processor individually or collectively, cause the MR headset device to continuously track interactions of a user with the UI components anchored to the determined region for manipulating the UI components.

In an embodiment, the instructions, when executed by the at least one processor individually or collectively, cause the MR headset device to determine one or more UI widgets supported by the at least one object of interest. In an embodiment, the instructions, when executed by the at least one processor individually or collectively, cause the MR headset device to determine one or more type of UI controls supported by the one or more UI widgets, wherein the one or more type of UI controls comprises at least one of a touch control, a gesture control and a glance control.

In an embodiment, the instructions, when executed by the at least one processor individually or collectively, cause the MR headset device to identify a minimum area requirement for displaying the UI components associated with the at least one object of interest. In an embodiment, the instructions, when executed by the at least one processor individually or collectively, cause the MR headset device to identify one or more UI widget templates satisfying the minimum area requirement. In an embodiment, the instructions, when executed by the at least one processor individually or collectively, cause the MR headset device to modify the one or more UI widget templates to include the UI components associated with the corresponding at least one object of interest.

In an embodiment, the instructions, when executed by the at least one processor individually or collectively, cause the MR headset device to identify, from a plurality of objects, one or more objects in a field of view (FOV) of a user present in the MR environment. In an embodiment, the instructions, when executed by the at least one processor individually or collectively, cause the MR headset device to determine, using an object classification model, an object type of the one or more objects. In an embodiment, the instructions, when executed by the at least one processor individually or collectively, cause the MR headset device to identify, from the one or more objects, the at least one object of interest based on the object type of the one or more objects.

In an embodiment, each of the one of more physical surfaces are segmented into the plurality of regions by employing one or more predefined region segmentation techniques.

In an embodiment, each region of the plurality of regions has a size greater than a predefined threshold.

In an embodiment, the predefined parameters comprise surface texture information, surface geometry information and surface localization information for each of the plurality of regions. In an embodiment, the predefined parameters comprise a distance from the at least one object of interest and an orientation with respect to the at least one object of interest. In an embodiment, the predefined parameters comprise a dimension of the at least one object of interest. In an embodiment, the predefined parameters comprise a size requirement for the one or more UI widgets and a type of control supported by the one or more UI widgets.

In an embodiment, the MR headset device is a video see through (VST) device or augment reality (AR) glasses.

In an embodiment, the instructions, when executed by the at least one processor individually or collectively, further cause the MR headset device to determine an object type of the at least one object of interest. In an embodiment, the instructions, when executed by the at least one processor individually or collectively, further cause the MR headset device to, based on the determined object type of the at least one object of interest, determine whether the at least one object of interest is a connected device or a remote device.

What is claimed is:

1. A method performed by a mixed reality (MR) headset device, comprising:
identifying, from an MR environment, at least one object of interest and one or more physical surfaces surrounding the at least one object of interest;
determining user interface (UI) components associated with the at least one object of interest based on identification information of the at least one object of interest;
determining, based on defined parameters, an interact-ability score for each of a plurality of regions segmented from the one or more physical surfaces, wherein the interact-ability score indicates a degree to which the each of the plurality of regions is suitable for user interaction;
determining a region for displaying the UI components associated with the at least one object of interest among the plurality of regions segmented from the one or more physical surfaces based on the determined interact-ability score; and
anchoring the UI components associated with the at least one object of interest to the determined region for accessing the at least one object of interest in the MR environment.

2. The method of claim 1, further comprising:
generating a final scene corresponding to the MR environment upon the anchoring the UI components.

3. The method of claim 2, further comprising:
continuously tracking interactions of a user with the UI components anchored to the determined region for manipulating the UI components.

4. The method of claim 1, wherein the identifying of the at least one object of interest comprises:
identifying, from a plurality of objects, one or more objects in a field of view (FOV) of a user present in the MR environment,
determining, using an object classification model, an object type of the one or more objects, and
identifying, from the one or more objects, the at least one object of interest based on the object type of the one or more objects.

5. The method of claim 1, wherein the determining of the UI components comprises:
determining one or more UI widgets supported by the at least one object of interest, and
determining one or more type of UI controls supported by the one or more UI widgets, wherein the one or more type of UI controls comprises at least one of a touch control, a gesture control, and a glance control.

6. The method of claim 1,
wherein the one or more physical surfaces are segmented into the plurality of regions by employing one or more defined region segmentation techniques, and
wherein the plurality of regions have a size greater than a defined threshold.

7. The method of claim 5, wherein the defined parameters comprise:
at least one of surface texture information, surface geometry information and surface localization information for the plurality of regions,
user preferences associated with a user,
a distance from the at least one object of interest and an orientation with respect to the at least one object of interest,
spatial context of the object of interest,
a dimension of the at least one object of interest,
a size requirement for the one or more UI widgets, or
a type of control supported by the one or more UI widgets.

8. The method of claim 1, further comprising:
identifying a minimum area requirement for displaying the UI components associated with the at least one object of interest;
identifying one or more UI widget templates satisfying the minimum area requirement; and
modifying the one or more UI widget templates to include the UI components associated with the corresponding at least one object of interest.

9. A mixed reality (MR) headset device comprises:
memory, comprising one or more storage media, storing instructions; and
at least one processor comprising processing circuitry, communicatively coupled to the memory,
wherein the instructions, when executed by the at least one processor individually or collectively, cause the MR headset device to:
identify, from an MR environment, at least one object of interest and one or more physical surfaces surrounding the at least one object of interest,
determine user interface (UI) components associated with the at least one object of interest based on identification information of the at least one object of interest,
determine, based on defined parameters, an interact-ability score for each of a plurality of regions segmented from the one or more physical surfaces, wherein the interact-ability score indicates a degree to which the each of the plurality of regions is suitable for user interaction,
determine a region for displaying the UI components associated with the at least one object of interest among the plurality of regions segmented from the one or more physical based on the determined interact-ability score, and
anchor the UI components associated with the at least one object of interest to the determined region for accessing the at least one object of interest in the MR environment.

10. The MR headset device of claim 9, wherein the instructions, when executed by the at least one processor individually or collectively, further cause the MR headset device to:
generate a final scene corresponding to the MR environment upon the anchoring the UI components.

11. The MR headset device of claim 10, wherein the instructions, when executed by the at least one processor individually or collectively, further cause the MR headset device to:
continuously track interactions of a user with the UI components anchored to the determined region for manipulating the UI components.

12. The MR headset device of claim 9,
wherein the instructions, when executed by the at least one processor individually or collectively, further cause the MR headset device to:
determine one or more UI widgets supported by the at least one object of interest, and
determine one or more type of UI controls supported by the one or more UI widgets, and
wherein the one or more type of UI controls comprises at least one of:
a touch control, a gesture control and a glance control.

13. The MR headset device of claim 9, wherein the instructions, when executed by the at least one processor individually or collectively, further cause the MR headset device to:
identify a minimum area requirement for displaying the UI components associated with the at least one object of interest,
identify one or more UI widget templates satisfying the minimum area requirement, and
modify the one or more UI widget templates to include the UI components associated with the corresponding at least one object of interest.

14. The MR headset device of claim 9, wherein the instructions, when executed by the at least one processor individually or collectively, further cause MR headset device to:
identify, from a plurality of objects, one or more objects in a field of view (FOV) of a user present in the MR environment,
determine, using an object classification model, an object type of the one or more objects, and
identify, from the one or more objects, the at least one object of interest based on the object type of the one or more objects.

15. The MR headset device of claim 9,
wherein the one or more physical surfaces are segmented into the plurality of regions by employing one or more defined region segmentation techniques, and
wherein the plurality of regions have a size greater than a defined threshold.

16. The MR headset device of claim 12, wherein the defined parameters comprise:
at least one of surface texture information, surface geometry information and surface localization information for the plurality of regions,
user preferences associated with a user,
a distance from the at least one object of interest and an orientation with respect to the at least one object of interest,
spatial context of the object of interest,
a dimension of the at least one object of interest,
a size requirement for the one or more UI widgets, or
a type of control supported by the one or more UI widgets.

17. The MR headset device of claim 9, wherein the MR headset device is a video see through (VST) device or augment reality (AR) glasses.

18. The MR headset device of claim 12, wherein the instructions, when executed by the at least one processor individually or collectively, further cause the MR headset device to:
determine an object type of the at least one object of interest, and
based on the determined object type of the at least one object of interest, determine whether the at least one object of interest is a connected device or a remote device.

19. One or more non-transitory computer-readable storage media storing one or more computer programs including computer-executable instructions that, when executed by one or more processors of a mixed reality (MR) headset device individually or collectively, cause the MR headset device to perform operations, the operations comprising:
identifying, from an MR environment, at least one object of interest and one or more physical surfaces surrounding the at least one object of interest;
determining user interface (UI) components associated with the at least one object of interest based on identification information of the at least one object of interest;
determining, based on defined parameters, an interact-ability score for each of a plurality of regions segmented from the one or more physical surfaces, wherein the interact-ability score indicates a degree to which the each of the plurality of regions is suitable for user interaction;
determining a region for displaying the UI components associated with the at least one object of interest among the plurality of regions segmented from the one or more physical surfaces based on the determined interact-ability score; and
anchoring the UI components associated with the at least one object of interest to the determined region for accessing the at least one object of interest in the MR environment.

20. The one or more non-transitory computer-readable storage media of claim 19, the operations further comprising:
generating a final scene corresponding to the MR environment upon the anchoring the UI components.
